(19) United States
(12) Patent Application Publication
(10) Pub. No.: US 2020/0056647 A1
(43) Pub. Date: Feb. 20, 2020

(54) FASTENER

(71) Applicant: TAIWAN SHAN YIN INTERNATIONAL CO., LTD., Kaohsiung City (TW)

(72) Inventor: KOU-TSAIR SU, KAOHSIUNG CITY (TW)

(21) Appl. No.: 16/104,325

(22) Filed: Aug. 17, 2018

(51) Int. Cl. F16B 25/00; F16B 25/10; F16B 35/06

(52) U.S. Cl. CPC F16B 25/0052; F16B 35/065; F16B 25/103

(57) ABSTRACT

A fastener includes a head with a top face and a conical bottom face, and a shank with a threaded portion spiraling thereon and a drilling portion. The head includes a plurality of cutting portions and cutting ribs formed on the bottom face to thereby cut and shave fibers and accommodate chips. Each cutting portion extends towards the shank and includes a projecting blade formed circumferentially of the top face, and an adjoining wall and a flank wall respectively connected to the projecting blade and meeting at a cutting edge. The cutting ribs extend radially relative to the shank. The cutting portions and the cutting ribs cooperate to continue cutting and press remnants and the bulge down so that the head fits flush with the surface of the workpiece to thereby increase the evenness and the fastening effect after the head is fastened in position.

### BACKGROUND OF THIS INVENTION

### 1. Field of this Invention

This invention relates to a fastener and relates particularly to a fastener allowing the head to fit flush with the workpiece to thereby ensure a perfect evenness and increase the fastening effect after the drilling operation is done.

### 2. Description of the Related Art

Referring to FIGS. 1 and 2, a conventional screw 1 includes a shank 12, a head 11 formed at one end of the shank 12, a drilling portion 13 formed at the other end of the shank 12, and threads 14 spirally disposed on the shank 12. The head 11 has a top surface 111 and a conical underside 112 extending downwards from the top surface 111. Spaced apart ribs 113 protrude from the underside 112 and extend fully from the top surface 111 to the shank 12. Accordingly, when the drilling portion 13 punctures a workpiece 2 with fibers and rotates the head 11 with a tool (not shown), the threads 14 keep drilling into a bore 21 and cut fibers. When the underside 112 touches the workpiece 2, the ribs 113 cut fibers and then the head 11 engages with the workpiece 2.

Because the workpiece 2 is formed with resilient wooden fibers, the spaced apart ribs 113 can only lift up the fibers but cannot break the fibers into chips completely. This incurs a poor cutting effect. Burrs caused by the ejected fibers may also stick out from the surface of the workpiece 2 when the head 11 is gradually cutting its way into the workpiece 2. The screw 1 does not provide any special arrangement to overcome the accumulation of the burrs, so the head 11 cannot fit flush with the surface of the workpiece 2 after the head 11 completes the drilling operation, and the fastening effect of the screw 1 is not good. Thus, the screw still needs improvement.

### SUMMARY OF THIS INVENTION

The object of this invention is to provide a fastener whose head can lie flush with the surface of the workpiece efficiently to promote the evenness after the drilling operation is done and increase the effect of fastening the fastener in position.

The fastener of this invention includes a head, a shank extending axially from the head and providing a drilling portion opposite to the head, and a threaded portion spirally disposed on the shank. The head has a top face and a conical bottom face extending from the top face to the shank. The head includes a plurality of cutting portions formed on the bottom face, a plurality of cutting ribs protruding from the bottom face, and a plurality of accommodation rooms formed between the cutting portions and the cutting ribs. Each cutting portion extends from the top face towards the shank and includes a projecting blade formed circumferentially of the top face at an outer edge thereof and extending in the direction of the shank, an adjoining wall and a flank wall respectively connected to the projecting blade and a cutting edge formed at a junction of the adjoining wall and the flank wall. The cutting ribs project from the bottom face and extend radially relative to the shank. The cutting ribs each have two rib walls protruding from the bottom face and meeting at a rib edge. Accordingly, the cutting ribs help cut unbroken fibers coming from the threaded portion, and the cutting portions continue scraping the cut material off to enhance the cutting ability and reduce the drilling resistance. The accommodation rooms receive part of the cut material to provide a firm engagement between the head and the workpiece. Burrs or a bulge produced during the drilling operation can be fully pressed down by the projecting blade and captured within a bore of the workpiece to allow the head to lie flush with the surface of the workpiece and thus attain a good evenness, thereby increasing the drilling efficiency and the fastening effect.

Preferably, in one embodiment, at least one cutting rib extends to be directed at a corresponding one of the cutting portions. In another embodiment, the cutting ribs extend respectively to be directed at part of the cutting portions so that the accommodation room can be extensively formed from the cutting portion to the shank between two adjacent cutting ribs to provide an enlarged space for receiving more chips.

Preferably, the projecting blade decreases progressively in the direction of the shank, and concurrently the adjoining wall extends from the cutting edge of one cutting portion to the flank wall of another adjacent cutting portion to allow the cutting portions to connect one after another.

Preferably, the threaded portion includes a first thread section spirally disposed on the drilling portion, a second thread section following the first thread section and formed in a wavy arrangement, and a third thread section following the second thread section. It is preferable that the second thread section has a second maximum outer diameter smaller than a third maximum outer diameter of the third thread section.

Preferably, threads of the second thread section are each provided with a plurality of notches.

Preferably, a helical portion can be formed between the threaded portion and the head to attain an anti-loosening effect.

Preferably, the rib walls of the cutting ribs are curved. It is also preferable that the adjoining wall is a curved wall to enlarge the space for receiving more chips.

### BRIEF DESCRIPTION OF THE DRAWINGS

FIG. 1 is a schematic view showing a conventional screw;

FIG. 2 is a bottom plan view taken on line A-A in FIG. 1;

FIG. 3 is a perspective view showing one variation of a first preferred embodiment of this invention;

FIG. 4 is an enlarged view showing the head of FIG. 3;

FIG. 5 is a bottom plan view taken on line B-B in FIG. 3;

FIG. 6 is a perspective view showing a further variation of the first preferred embodiment of this invention;

FIG. 7 is an enlarged view showing the head of FIG. 6;

FIG. 8 is a bottom plan view taken on line C-C in FIG. 6;

FIGS. 9 to 11 are schematic views showing the fastener of this invention in use;

FIG. 12 is a front elevational view showing a second preferred embodiment of this invention;

FIG. 12A is an enlarged view of FIG. 12;

FIG. 13 is a front elevational view showing a third preferred embodiment of this invention; and

FIG. 13A is an enlarged view of FIG. 13.

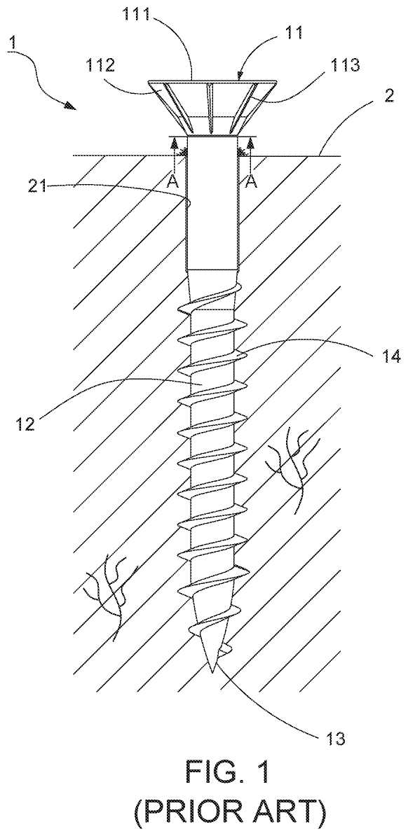

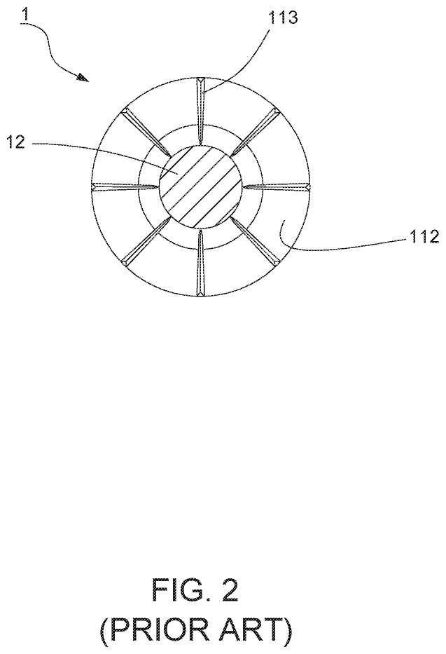

### DETAILED DESCRIPTION OF THE PREFERRED EMBODIMENTS

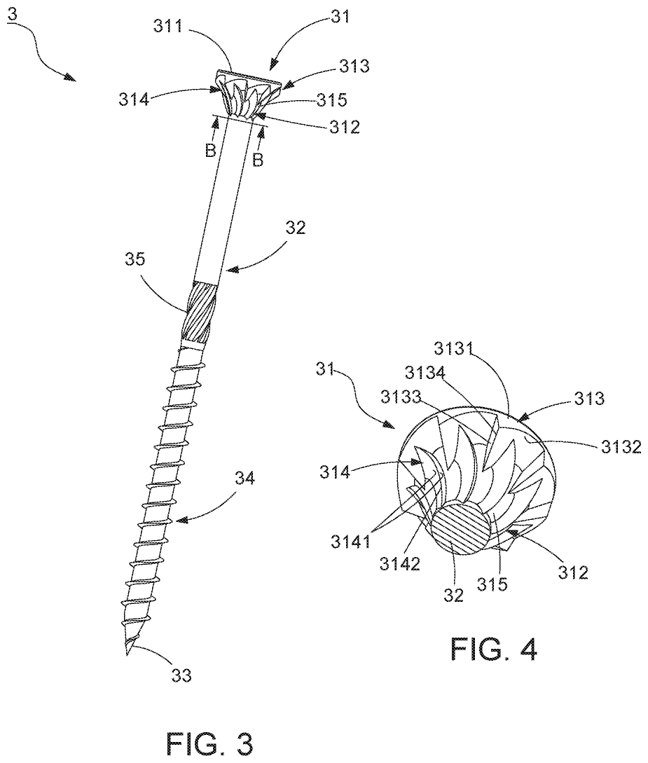

Referring to FIGS. 3 to 5, a fastener 3 of a first preferred embodiment of this invention includes a head 31, a shank 32 extending axially from the head 31 and providing a drilling portion 33 opposite to the head 31, and a threaded portion 34 spirally disposed on the shank 32. The drilling portion 33 can be formed with a sharp point (illustrated as an example) or a drilling tip with a groove or grooves.

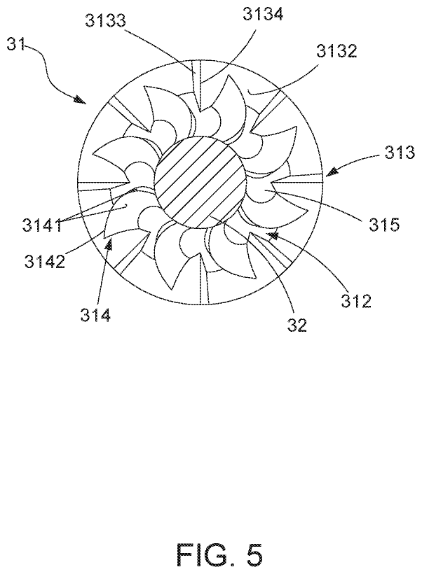

The head 31 has a top face 311 and a bottom face 312 extending from the top face 311 to the shank 32 and formed in a cone shape. On the bottom face 312 are formed a plurality of cutting portions 313, a plurality of cutting ribs 314 protruding from the bottom face 312 and extending radially relative to the shank 32, and a plurality of accommodation rooms 315 formed between the cutting portions 313 and the cutting ribs 314. Each cutting portion 313 extends circumferentially of the top face 311 towards the shank 32. It is preferable that the cutting portion 313 extends from the top face 311 and terminates short of the shank 32. In addition, each cutting portion 313 includes a projecting blade 3131 formed circumferentially of the top face 311 at an outer edge thereof and extending in the direction of the shank 32, an adjoining wall 3132 and a flank wall 3133 respectively connected to the projecting blade 3131, and a cutting edge 3134 formed at a junction where the walls 3132, 3133 meet. In the preferred embodiments, it is preferable that each blade 311 decreases progressively from the top face 311 and becomes tapered in the direction of the shank 32. Concurrently, the adjoining wall 3132 extends from the cutting edge 3134 of one cutting portion 313 to the flank wall 3133 of another adjacent cutting portion 313. For example, FIGS. 4 and 5 show that the flank wall 3131 has a bottom edge opposite to the cutting edge 3134, and particularly the adjoining wall 3132 can extend from the cutting edge 3134 of one cutting portion 313 to the bottom edge of another adjacent flank wall 3131. Thus, the adjoining walls 3132 are connected one after another, namely are continuously connected. The adjoining wall 3132 may have a flat surface or a curved surface. It is adopted in the preferred embodiments that the adjoining wall 3132 is curved, preferably concavely curved as shown, and the cutting edge 3134 can also be inclined because of the curved adjoining wall 3132.

The cutting ribs 314 are spaced from each other and extend radially relative to the shank 32. For example, one end of the cutting rib 314 may be connected to the shank 32 (shown in FIG. 4) or may be close to but not exactly connected to the shank 32. As an example in the preferred embodiments, FIGS. 3 to 5 illustrate the cutting rib 314 starting from the shank 32. Further, each cutting rib 314 has two rib walls 3141 protruding from the bottom face 312 and meeting at a rib edge 3142. The rib wall 3141 can be curved to benefit the cutting operation.

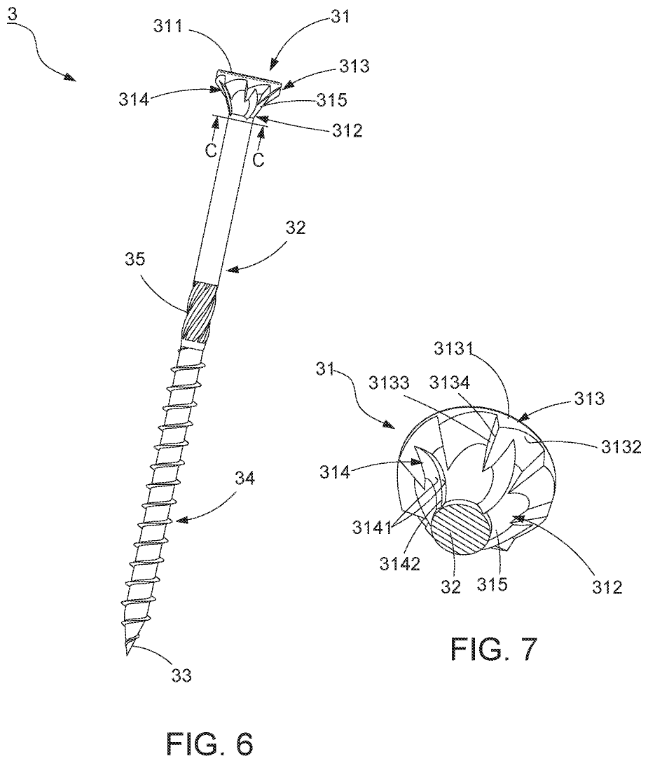

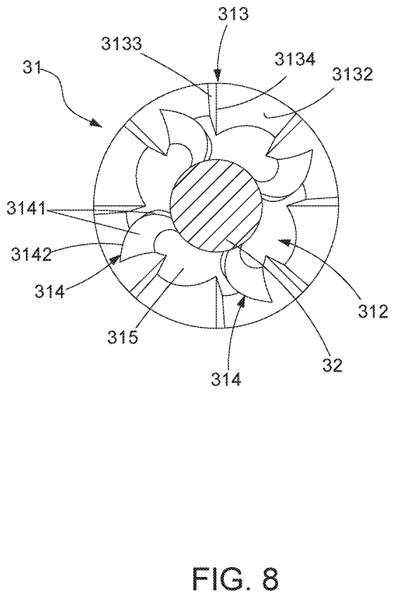

The cutting ribs 314 can extend in a radial direction to be directed at corresponding ones of the cutting portion 313. For example, as shown in FIGS. 3 and 4, one end of at least one cutting rib 314 extends from the shank 32, and the other end thereof reaches a corresponding one cutting portion 313. It may be possible that the other end of the cutting rib 314 stops at a point near the cutting portion 313 (not shown). Further, the other end of the cutting rib 314 can touch any wall of the cutting portion 313, and it is shown as an example in FIG. 5 that each cutting rib 314 reaches each adjoining wall 3132. Alternatively, as shown in FIGS. 6 and 7, the cutting ribs 314 extend respectively to be directed at part of the cutting portions 313. This shows that when one ends of the cutting ribs 314 extend radially from the shank 32, the other ends thereof extend to or toward part of the cutting portions 313 so that between every two adjacent cutting ribs 314 is defined the accommodation room 315 extensively formed from the cutting portion 313 to the shank 32 to enlarge the space (as shown in FIG. 8). Likewise, the cutting ribs 314 each reach any wall of the corresponding cutting portions 313, e.g. the adjoining wall 3132, as shown in FIG. 8, or terminate short of the cutting portions 313 (not shown). The arrangement of FIG. 6 will be described as an example in the following operation. Furthermore, the curved shape of the adjoining wall 3132 helps enlarge the space of the accommodation room 315.

In this preferred embodiment, a helical portion 35 can be formed on the shank 32, preferably formed between the threaded portion 34 and the head 31. The helical portion 35 is inclined by a leading angle different from a spiral angle of the threaded portion 34 to follow the threaded portion 34 and continue the drilling action.

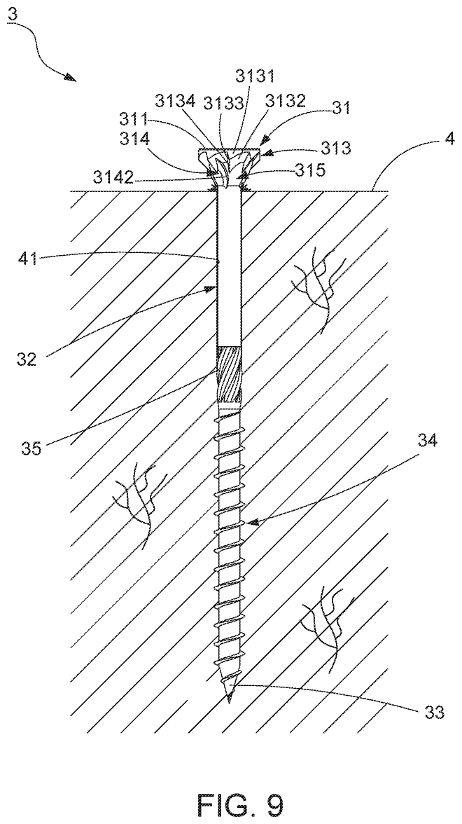

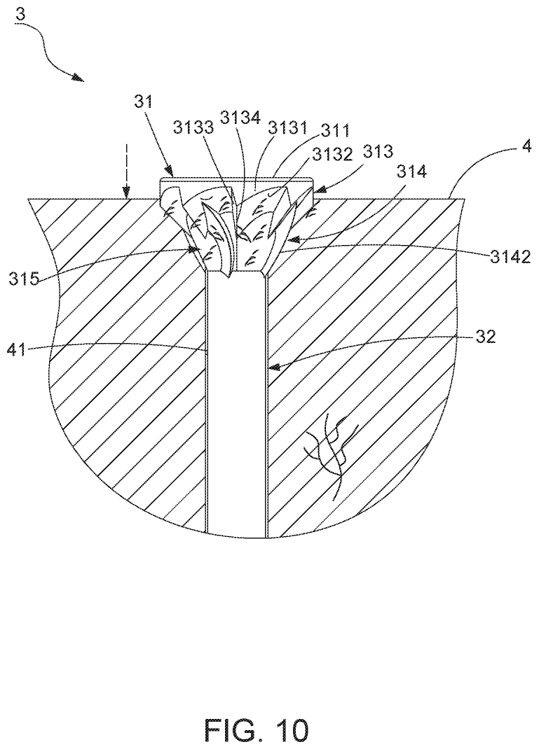

Referring to FIG. 9, when a driving tool (not shown) is engaged with the head 31 and a driving torque is added to the fastener 3, the drilling portion 33 and the threaded portion 34 start drilling into a workpiece 4 such as a hardwood to form a bore 41 on a surface of the workpiece 4 and concurrently cutting fibers of the workpiece 4 into chips to thereby drill the shank 32 into the workpiece 4 quickly. As the helical portion 35 follows the drilling track of the threaded portion 34 and enters the workpiece 4, the helical portion 35 engages with an inner wall of the workpiece 4 firmly because of its leading angle different from the spiral angle of the threaded portion 34 and the elasticity of the cut materials. This arrangement allows the chips to be inwardly pressed and attains an anti-loosening effect. When head 31 advances and touches the surface of the workpiece 4, the rib edges 3142 of the cutting ribs 314 subject the fibers left around the bore 41 to a cutting operation. In other words, the rib edges 3142 cuts and severs unbroken fibers escaping from the threaded portion 34 into small chips firstly and also enlarges the bore 41 progressively to become a countersunk hole, as shown in FIG. 10. The cutting edges 3134 follow the rib edges 3142 to continue cutting and shaving chips. Thus, the cutting edges 3134 cooperate with the rib edges 3142 to attain a double cutting effect. This ensures that the fibers are well cut and scraped off, prevents the head 31 from being subjected to the undue entanglement of the fibers, and prevents a drilling resistance caused by the entanglement of the fibers.

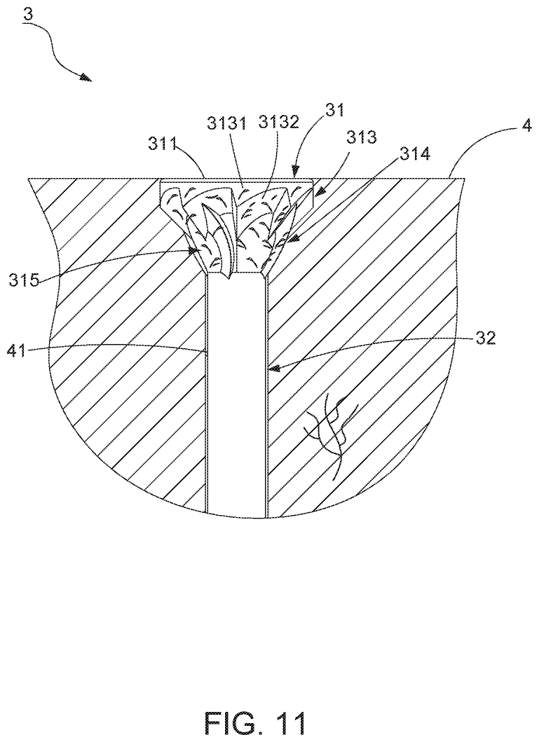

When the head 31 continues the cutting action, redundant chips run gradually along the adjoining wall 3132 and are ejected from the workpiece 4 to prevent an undue accumulation of chips from pressurizing the workpiece 4, reduce the resistance and prevent the workpiece 4 from cracking. The enlarged space of the accommodation room 315 also receives more chips to increase the engagement between the fastener 3 and the workpiece 4. As shown in FIG. 9, it is possible that when the head 31 is gradually screwed into the bore 41, remnants such as burrs may be produced because of the fibers or chips forced out of the workpiece 4 during the rotation of the fastener 4 or at least a bulge may stick out from the surface of the workpiece 4. The extension of the projecting blade 3131 presses the burrs and the bulge downwards to make them move down back into the bore 41 of the workpiece 4, as arrowed in FIG. 10. Therefore, the top face 311 of the head 31 lies flush with the surface of the workpiece 4, as shown in FIG. 11, to promote the evenness after the head 31 completes the entire drilling action and reaches its countersunk position and to increase the engagement between the fastener 3 and the workpiece 4.

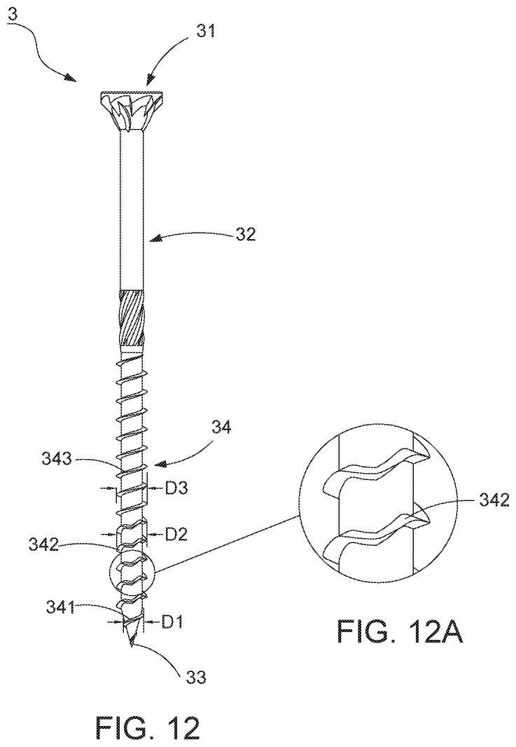

FIG. 12 shows a second preferred embodiment of this invention whose correlated elements are the same as the first preferred embodiment. This embodiment is characterized in that the threaded portion 34 includes a first thread section 341 spirally disposed on the drilling portion 33, a second thread section 342 following the first thread section 341, and a third thread section 343 following the second thread section 342. Preferably, the three thread sections can be connected in sequence to construct a single convolution, as shown. Particularly, the second thread section 342 provides a thread crest lying like waves rising and falling, as shown in FIG. 12A. Further, the second thread section 342 has a second maximum outer diameter D2 smaller than a third maximum outer diameter D3 of the third thread section 343 and larger than a first maximum outer diameter D1 of the first thread section 341.

The cooperation between the three thread sections with different outer diameters benefits a good drilling and fastening effect. Specifically, the first thread section 341 assists the drilling portion 33 in performing a pilot drilling operation. The second thread section 342 moves along a drilling track created by the first thread section 341 and uses its wavy crest to continue cutting. In other words, the wavy second thread section 342 increases cutting points to enhance the cutting capability and reduce resistance. The wavy arrangement also benefits removal of redundant chips and allows a certain amount of chips to stay among the second thread section 342 to thereby attain an anti-loosening effect and prevent cracks in the workpiece. The second maximum outer diameter D2 larger than the first maximum outer diameter D1 also helps a reaming action and allows the chips to move upwards to the third thread section 343. When the third thread section 343 with the third maximum outer diameter D3 is gradually drilled into the workpiece, partial chips coming from the second thread section 342 can be pressed inwards to enhance the engagement between the third thread section 343 and the workpiece (not shown in FIG. 12). Therefore, the threaded portion 34 with different types of thread sections 341, 342, 343 allows the fastener 3 to be quickly drilled into the workpiece, reduces resistance during the drilling operation, and contributes to improved forces preventing the fastener 3 from being pulled out of the workpiece. By this arrangement, an undue accumulation of chips is avoided, and the workpiece such as a hardwood does not crack easily. This also benefits the effect of fitting the head 31 level with the workpiece and helps a stable fastening effect.

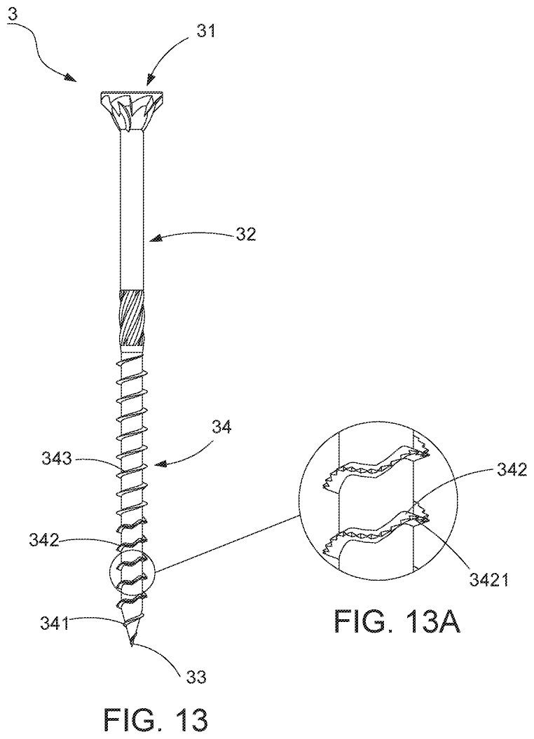

FIG. 13 shows a third preferred embodiment of this invention whose correlated elements are the same as the second preferred embodiment. This embodiment is characterized in that threads of the second thread section 342 are each provided with a plurality of notches 3421, and the notches 3421 are formed along the wavy form of the second thread section 342 to be open in different directions. These notches 3421 can be in a continuous connection to become serrated as shown in FIG. 13A, or be spaced from each other. Accordingly, the notches 3421 provides multiple cutting points to increase the cutting ability of the threaded portion 34, speed up the cutting and drilling operation and help removal of chips. The friction resistance and torque generated during the drilling operation can be greatly reduced. Cut materials like chips can also be received within the notches 3421 to enhance the engagement between the fastener 3 and the workpiece (not shown in FIG. 13), thereby increasing the ability of resisting the pulling-out force. This also benefits the effect of fitting the head 31 level with the workpiece and helps a stable fastening effect.

To sum up, this invention takes advantages of cutting portions and cutting ribs formed on the bottom face to subject unbroken fibers coming from the threaded portion to a continuous cutting and shaving action, thereby reducing the drilling resistance. Accommodation rooms formed between the cutting portions and the cutting ribs also receive sufficient chips to increase the engagement between the fastener and the workpiece. Remnants, burrs and the bulge sticking out from the workpiece can be fully pressed down into the bore by the projecting blade formed circumferentially of the top face when the head is cutting its way into the workpiece. After the head is completely screwed into the workpiece, the entire head lies flush with the surface of the workpiece to promote the evenness, and the fastening effect is increased.

While the embodiment of this invention is shown and described, it is understood that further variations and modifications may be made without departing from the scope of this invention.

What is claimed is:

1. A fastener comprising a head, a shank extending axially from said head and providing a drilling portion opposite to said head, and a threaded portion spirally disposed on said shank, said head having a top face and a conical bottom face extending from said top face to said shank;
wherein said head includes a plurality of cutting portions formed on said bottom face, a plurality of cutting ribs protruding from said bottom face, and a plurality of accommodation rooms formed between said plurality of cutting portions and said cutting ribs;
wherein each of said cutting portions extends from said top face towards said shank and includes a projecting blade formed circumferentially of said top face at an outer edge thereof and extending in the direction of said shank, an adjoining wall and a flank wall respectively connected to said projecting blade and a cutting edge formed at a junction of said adjoining wall and said flank wall; and
wherein said plurality of cutting ribs project from said bottom face and extend radially relative to said shank, said cutting ribs each having two rib walls protruding from said bottom face and meeting at a rib edge.

2. The fastener according to claim 2, wherein said projecting blade decreases progressively in the direction of said shank, each of said adjoining walls extending from said cutting edge of one cutting portion to said flank wall of another adjacent cutting portion.

3. The fastener according to claim 1, wherein at least one cutting rib extends to be directed at a corresponding one of said cutting portions.

4. The fastener according to claim 2, wherein at least one cutting rib extends to be directed at a corresponding one of said cutting portions.

5. The fastener according to claim 1, wherein said cutting ribs extend respectively to be directed at part of said cutting portions, each of said accommodation rooms being formed from said cutting portion to said shank between two adjacent cutting ribs.

6. The fastener according to claim 2, wherein said cutting ribs extend respectively to be directed at part of said cutting portions, each of said accommodation rooms being formed from said cutting portion to said shank between two adjacent cutting ribs.

7. The fastener according to claim 1, wherein said threaded portion includes a first thread section spirally disposed on said drilling portion, a second thread section following said first thread section and formed in a wavy arrangement, and a third thread section following said second thread section, said second thread section having a second maximum outer diameter smaller than a third maximum outer diameter of said third thread section.

8. The fastener according to claim 7, wherein threads of said second thread section are each provided with a plurality of notches.

9. The fastener according to claim 1, wherein a helical portion is formed between said threaded portion and said head.

10. The fastener according to claim 1, wherein said rib walls of said cutting ribs are curved.

11. The fastener according to claim 1, wherein said adjoining wall is a curved wall.
